(19) United States
(12) Patent Application Publication
(10) Pub. No.: US 2016/0144377 A1
(43) Pub. Date: May 26, 2016

(54) RECOVERY TROUGH WITH CONVEYOR FOR VIBRATORY SEPARATOR AND METHOD

(71) Applicant: M-I L.L.C., Houston, TX (US)

(72) Inventors: Perry D. Lomond, Houston, TX (US); Venkata Kasi Amaravadi, Tomball, TX (US); Colin Stewart, Houston, TX (US); Richard Bingham, Houston, TX (US)

(21) Appl. No.: 14/948,789

(22) Filed: Nov. 23, 2015

Related U.S. Application Data
(60) Provisional application No. 62/084,988, filed on Nov. 26, 2014.

(51) Int. Cl. B03B 7/00

(52) U.S. Cl. CPC B03B 7/00

(57) ABSTRACT

An apparatus includes a vibratory separator having a first deck, a second deck, and a third deck, and a collection trough coupled to at least one of the first deck, the second deck and the third deck. The collection trough includes a conveying apparatus configured to convey a material in the collection trough to an outlet of the collection trough disposed proximate a first end of the collection trough.

### CROSS-REFERENCE TO RELATED APPLICATIONS

This application claims benefit of U.S. patent application Ser. No. 62/084,988, filed Nov. 26, 2014 and titled RECOVERY THROUGH WITH CONVEYOR FOR VIBRATORY SEPARATOR AND METHOD, the entire disclosure of which is herein incorporated by reference.

### BACKGROUND

Various industries, such as oil and gas, mining, agriculture and the like utilize equipment and/or methods to separating fluids from materials. For example, in the mining industry, the separation of a desired mineral component from the undesirable gangue of an ore is a necessary and significant aspect of mining. Tailings are the materials left over after the process of separating the valuable ore from the gangue. Mine tailings are usually produced from a mill in slurry form that is typically a mixture of fine mineral particles and water.

Another example of such a separation method is found in the oil and gas industry. For example, oilfield drilling fluid, often called “mud,” serves multiple purposes in the oil and gas industry. Among its many functions, the drilling mud acts as a lubricant for a drilling bit and increases rate of penetration of the drilling bit. The mud is pumped through a bore of the drill string to the drill bit where the mud exits through various nozzles and ports, lubricating the drill bit. After exiting through the nozzles, the “spent” fluid returns to the surface through an annulus formed between the drill string and the drilled wellbore. The returned drilling mud is processed for continued use.

Another purpose of the drilling mud is to carry the cuttings away from the drill bit to the surface. The drilling fluid exiting the borehole from the annulus is a slurry of formation cuttings in drilling mud, and the cutting particulates must be removed before the mud is reused.

One type of apparatus used to remove cuttings and other solid particulates from drilling mud is commonly referred to in the industry as a “shaker” or “shale shaker.” The shaker, also known as a vibratory separator, is a vibrating sieve-like table upon which returning used drilling mud is deposited and through which substantially cleaner drilling mud emerges.

Drilling fluids containing bridging materials, also known in the art as wellbore strengthening materials or lost circulation materials (LCM), have seen increased use in drilling operations where natural fractures in the wellbore allow drilling fluid to escape from the circulating system. Wellbore strengthening materials are typically mixed into the drilling fluid and used to bridge the fractures to prevent fluid loss into the formation. Such wellbore strengthening materials are also used in stress cage drilling, which involves intentionally creating fractures in the wellbore and bridging the fractures with the materials.

Wellbore strengthening materials typically are more expensive than other additives used in drilling fluid components. Thus, wellbore strengthening materials may be recovered during waste remediation for reuse.

### BRIEF DESCRIPTION OF DRAWINGS

The foregoing and other features of the present disclosure will become more fully apparent from the following description, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

FIG. 1 is a cross-section view of a vibratory separator according to embodiments of the present disclosure.

FIG. 2 is a cut away perspective view of a collection trough having a conveyor apparatus disposed therein according to embodiments of the present disclosure.

FIG. 3 is a cut away perspective view of a collection trough, in which a conveyor apparatus forms a bottom surface of the collection trough, according to embodiments of the present disclosure.

FIG. 4 is a close-up view of a first end of a collection trough according to embodiments of the present disclosure.

FIG. 5 is a cut way perspective view of a collection trough having a conveyor apparatus with a plurality of flaps disposed thereon according to embodiments of the present disclosure.

### DETAILED DESCRIPTION

In one aspect, embodiments disclosed herein relate generally a wellbore strengthening material collection system for collecting wellbore strengthening materials. In another aspect, embodiments disclosed herein relate to vibratory separator components for collecting wellbore strengthening materials during drilling operations. In another aspect, embodiments disclosed herein relate to methods of directing, conveying, and collecting wellbore strengthening materials during drilling operations.

Vibratory separators use filtration screens to separate solids from fluids and to separate solids of different sizes. For example, shakers use filtration screens to separate drill cuttings from drilling fluid in on-shore and off-shore oilfield drilling. The separating screens have a mesh stretched across a frame. The mesh allows particles and/or fluid below a predetermined size to pass through the separating screen. The separating screen is vibrated while the mixture of particles and/or fluids is deposited on an input side. The vibration improves separation and conveys the remaining particles to a discharge end of the separating screen.

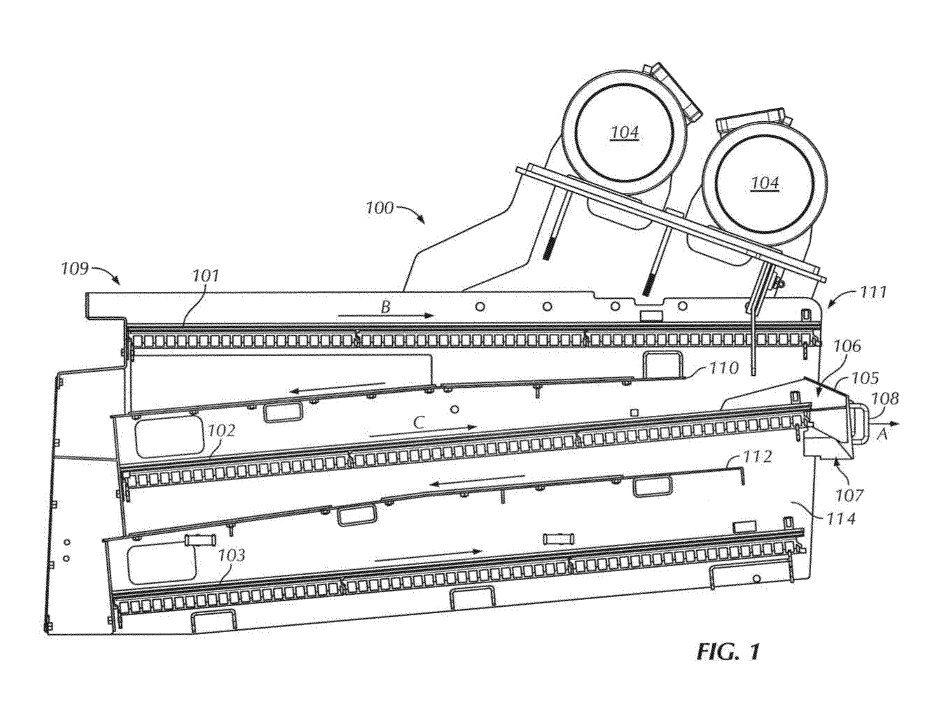

Referring to FIG. 1, a cross-section plan view of a vibratory separator having a collection trough according to embodiments of the present disclosure is shown. In this embodiment, vibratory separator 100 includes three decks 101, 102, and 103, wherein top deck 101 is a scalping deck, middle deck 102 is a second cut deck, and bottom deck 103 is a fines deck. Vibratory separator 100 also includes two motion actuators 104 configured to provide a motion to decks 101, 102, and 103 during operation. As illustrated, a collection trough 105 is in fluid communication with middle deck 102. Collection trough 105 may be formed from various materials, such as steel, and may include various coatings to prevent corrosion during operation.

Each deck 101, 102, and 103 may include one or more screens (not independently illustrated). The screens include a plurality of perforations of a particular size, thereby allowing fluids and solids entrained therein that are smaller than the size of the perforations to flow through the screens, while particular matter larger than the screen is retained on top of the screen for further processing. Those of ordinary skill in the art will appreciate that the screens on each of decks 101, 102, and 103 may have different perforation sizes, such that the over flow (the retained solids) from each screen are a different sizes. In such an embodiment, the retained solids from deck 101 may be of a larger size than the retained solids from decks 102 and 103. Thus, by selecting different perforation size for screens on decks 101, 102, and 103, a specific solid size from each deck may be retained. Those of ordinary skill in the art will appreciate that depending on the requirements of a reparatory operation, one or more of the screens on decks 101, 102, and/or 103 may also have screens with perforations of the same or substantially the same size.

As drilling fluid containing particulate matter (slurry) enters vibratory separator 100 though an inlet side 109, the slurry flows in direction B, such that fluid and undersized particles form an underflow (i.e., fluids and particulate matter that passes through screens), pass through a screen on first deck 101 and into a first flow back pan 110. The overflow (e.g., drill cuttings or large solids) that did not pass through the screen(s) on first deck 101 may then be discharged from first deck 101 at large particulate discharge point 111. The underflow then flows down first flowback pan 110 and onto deck 102. The mesh used on screens of the deck 102 may be selected such that a predetermined material size or material, such as wellbore strengthening materials, is retained on screen 102. Thus, fluids and particulate matter smaller than the perforations in the screen(s) on deck 102 fall through middle deck 102 screen and onto second flowback pan 112, while wellbore strengthening materials are retained on the screen(s) and moved in direction C.

Vibratory separator 100 also includes a collection trough 105 coupled to at least one of the decks 101, 102, or 103 of vibratory separator 100. In this embodiment, collection trough 105 is illustrated coupled to middle deck 102. As illustrated, collection trough 105 is configured to receive a flow of solid overflow from the second deck 102, which includes solids that are too large to fit through the perforations in a screen on second deck 102. In certain aspects, the solids that are collected in collection trough 105 may include wellbore strengthening materials, such as fluid wellbore strengthening materials that are designed to lower the volume of filtrate that passes through a filter medium and into the formation. Examples of wellbore strengthening materials, including lost circulation materials, include sized-salts, sized-calcium carbonates, polymers, sand, mica, nutshells (e.g., ground peanut shells and walnut shells), plant fibers, cottonseed hulls, ground rubber, other wellbore strengthening materials known in the art.

Collection trough 105, in this aspect, includes an inlet 106 configured to receive an overflow from the second deck 102 and an outlet 107 configured to direct the overflow to a storage vessel or the active drilling fluid system. The active drilling fluid system may include drilling fluid tanks, mixing tanks, or other containers located at the drilling site, where drilling fluids are mixed and stored prior to use during drilling. Collection trough 105 may include handles 108, which are configured to allow an operator to remove collection trough 105 when either wellbore strengthening materials are not being used or when collection of such wellbore strengthening materials is not required. In certain aspects, it may be desirable for the reparatory operation to continue without the collection of wellbore strengthening materials. In such an operation, the operator may simply remove collection trough 105 from second deck 102 by sliding collection trough 105 in direction A. In certain embodiments, collection trough 105 may be secured to second deck through mechanical attachment points, such as bolts or screws, while in other aspects, collection trough 105 may be secured to deck 102 through a pneumatic actuation system, such as pneumatic systems typically used to secure screens to decks.

Those of ordinary skill in the art will appreciate that collection trough 105 may be disposed on other decks, such as first deck 101 or third deck 103 in certain separatory operations. For example, in a return flow of drilling fluid with high solids content, it may be beneficial to collect wellbore strengthening materials from third deck 103, while in other operations, it may be beneficial to collect wellbore strengthening materials from first deck 101. In still other aspects, a collection trough may be used on more than one deck to collect multiple sized wellbore strengthening materials. Additionally, the location of collection trough 105 may be selected based on the perforation size of the screens on a particular deck or based on the size of the wellbore strengthening materials being collected.

Fluids and particulate matter that is smaller than a perforation size of a screen on deck 102 do not enter collection trough 105; rather, the fluids and fine particulate matter pass through the screen on middle deck 102 onto flow back pan 112. In a final separatory action, fluids and particulate matter (fine) smaller than a screen on deck 103 flow through the screen into a reservoir or sump in vibratory separator 100 that is in fluid communication with the active drilling fluid system. Fines that are larger than the perforation on screens disposed on the bottom deck 103 are discharged from the vibratory separator at discharge point 114 for disposal thereafter.

In certain applications the flow through vibratory separator 100 may be modified by, for example, providing for a bypass of one or more of the decks 101, 102, and/or 103. Additionally, series and/or parallel flow may be achieved by diverting a flow of fluid around one or more of decks 101, 102, 103, or away from one or more of flow back pans 110 and/or 112.

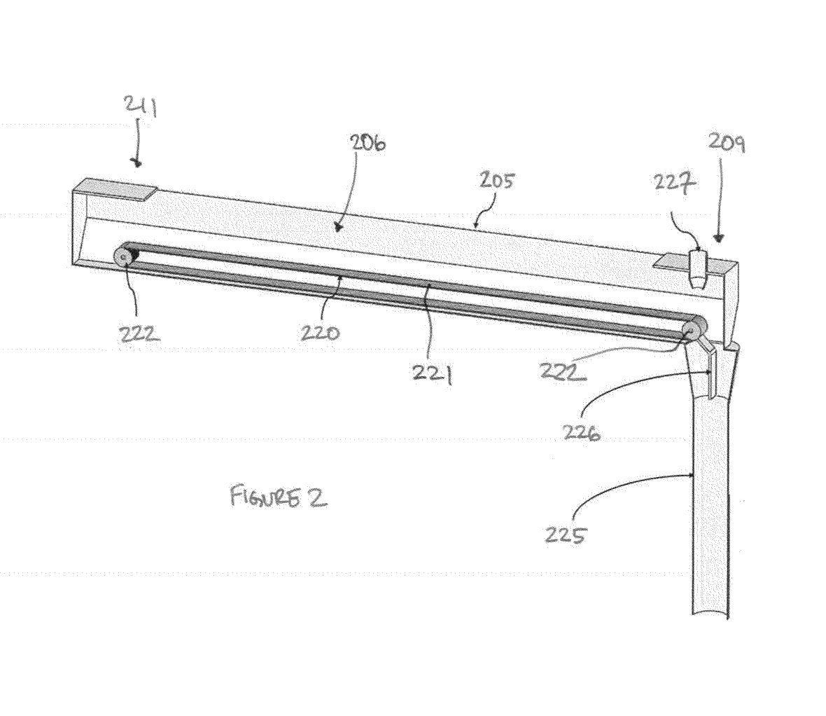

Embodiments disclosed herein may provide for apparatuses for collecting wellbore strengthening materials during drilling operations. For example, referring to FIG. 2, a cut away perspective view of a collection trough 205 having a conveyor apparatus 220 disposed therein according to embodiments of the present disclosure is shown. As shown, the collection trough 205 includes a first end 209 and a second end 211 and a first side extending between the first end 209 and the second end 211. In one or more embodiments, the collection trough 205 may be removably coupled to an end of a screen deck (e.g., decks 101, 102, and/or 103 discussed above) of a vibratory separator (not shown) and may receive a solids portion of materials being filtered by the vibratory separator. By being removably coupled to an end of a screen deck of a vibratory separator, a single vibratory separator may be used in drilling operations where wellbore strengthening materials are used during certain portions of drilling and are not used in other portions of drilling.

Further, as shown in FIG. 2, the collection trough 205 includes an inlet 206 configured to receive an overflow (e.g., a solids portion of materials being filtered by the vibratory separator) from a screen deck (not shown), and the first end 209 may include an outlet configured to direct the overflow to a storage vessel (not shown) or an active drilling fluid system (not shown).

As shown in FIG. 2, the collection trough 205 includes the conveyor apparatus 220 disposed therein and an outlet pipe 225 disposed proximate the first end 209 of the collection trough 205. In one or more embodiments, the conveyor apparatus 220 may include a conveyor belt 221 and a plurality of rollers 222. As shown in FIG. 2, the conveyor apparatus 220 includes two rollers 222. However, embodiments disclosed herein are not limited to embodiments having two rollers. For example, in one or more embodiments, the conveyor apparatus 220 may include three, four, five, or more rollers, which may be substantially similar to the rollers 222 and may be disposed adjacent to or anywhere between the rollers 222 shown in FIG. 2.

Further, in one or more embodiments, the conveyor belt 221 may be a wraparound conveyor belt and may include one or more layers that may be formed from a variety of materials and are not limited to rubber (e.g., non-stick rubber), plastic (e.g., nylon), polyester, cotton, metal, or a combination thereof. In one or more embodiments, the conveyor belt 221 may include overlapping flaps that are configured to mesh and un-mesh. Further, in one or more embodiments, the conveyor belt 221 may be textured or perforated.

In one or more embodiments, the conveyor belt 221 may be disposed around the plurality of rollers 222, and the plurality of rollers 222 may be configured to rotate in a first direction such that the conveyor belt 221 may also rotate in the first direction. For example, the plurality of rollers 222 shown in FIG. 2 may rotate in a clockwise direction, which may cause the conveyor belt 221 to also rotate in the clockwise direction. Rotating the conveyor belt 221 in the clockwise direction may cause materials (not shown) disposed on the conveyor belt 221 to be conveyed or displaced from the second end 211 of the collection trough 205 toward the first end 209 of the collection trough 205 and toward the outlet pipe 225. Alternatively, in one or more embodiments, the outlet pipe 225 may be disposed on the second end 211 of the collection trough 205, and the plurality of rollers 222 may be configured to rotate in the counter-clockwise direction, which may cause the conveyor belt 221 to also rotate in the counter-clockwise direction. Rotating the conveyor belt 221 in the counter-clockwise direction may cause materials disposed on the conveyor belt 221 to be conveyed or displaced from the first end 209 of the collection trough 205 toward the second end 211 of the collection trough 205.

The plurality of rollers 222 may be configured to rotate in a first direction or a second direction (e.g., the clockwise direction or the counter-clockwise direction) by way of any of a variety of motors and rotation mechanisms. For example, in one or more embodiments, one or more of the plurality of rollers 222 may be forced to rotate (i.e., powered) in either the first direction or the second direction directly by an electric motor or a pneumatic motor, or indirectly through a gear box. Alternatively, the plurality of rollers 222 may be powered by a system including one or more magnets, such that the repulsion force of the one or more magnets provide the driving force used to rotate the plurality of rollers 222.

Further, in one or more embodiments, only one of the plurality of rollers 222 may be powered or driven, and the remaining rollers 222 may be free to rotate with the conveyor belt 221. For example, in one or more embodiments, the roller 222 proximate the second end 211 of the collection trough 205 may be coupled to a motor as described above, and the roller 222 proximate the first end 209 of the collection trough 205 may be free to rotate. As such, the roller 222 proximate the second end 211 of the collection trough 205 may be powered or driven by a motor described above to rotate in a first direction, which may cause the conveyor belt 221 to rotate in the first direction. Rotation of the conveyor belt 221 in the first direction may then cause the roller 222 proximate the first end 209 of the collection trough 205 to also rotate in the first direction due to the contact between the conveyor belt 221 and the roller 222 proximate the first end 209 of the collection trough 205. Thus, one or more of the plurality of rollers 222 may be driven or powered, while the remaining rollers 222 may be free to rotate in either the first direction or the second direction with the conveyor belt 221. Furthermore, in one or more embodiments, one or more of the plurality of rollers 222 may be spring mounted proximate a bottom surface of the collection trough 305. As such, in one or more embodiments, one or more of the plurality of rollers 222 may be biased in a direction and retained by a spring mount (not shown). By including spring mounted rollers, the plurality of rollers 222, and therefore the conveyor belt 221, may be positioned in close proximity to a bottom surface of the trough, such that a lower portion of the conveyor belt 221 (i.e., a portion of the conveyor belt 221 below the plurality of rollers 222 during operation) contacts the bottom surface of the trough. Contact between the conveyor belt 221 and the bottom surface of the collection trough 205 may provide a seal to prevent the collected overflow from becoming stuck below the conveyor belt 221.

In one or more embodiments, the collection trough 205 may be oriented or tilted toward the outlet pipe 225. In other words, in one or more embodiments, the outlet pipe 225 may be disposed proximate the first end 209 of the collection trough 205, and the first end 209 of the collection trough 205 may be at a lower height than the second end 211 of the collection trough 205. Orienting the collection trough 205 such that the first end 209 is at a lower height than the second end 211 may encourage flow of any materials disposed within the collection trough 205 toward the outlet pipe 225. For example, a bottom surface of the collection trough 205 may be angled such that the bottom surface slopes linearly downward from the second end 211 to the first end 209. Alternatively, in one or more embodiments, the outlet pipe 225 may be disposed on the second end 211 of the collection trough 205, and the collection trough 205 may be oriented or tilted toward the outlet pipe 225 such that the first end 209 may be at a higher height than the second end 211, which may encourage flow of any materials disposed within the collection trough 205 toward the outlet pipe 225.

Furthermore, as shown in FIG. 2, the collection trough 205 includes a fluid inlet nozzle 227 disposed proximate the first end 209 of the collection trough 205. In one or more embodiments, the fluid inlet 227 may be positioned above or proximate to the outlet pipe 225 and may allow additional fluid to be introduced into the collection trough 205. The fluid inlet may be coupled to an external fluid source. In one or more embodiments, the additional fluid introduced into the collection trough 205 through the fluid inlet nozzle 227 may mix with the materials being conveyed or displaced by the conveyor apparatus 220 toward the outlet pipe 225 and may reduce the viscosity of a material mixture (e.g., the materials that were conveyed or displaced by the conveyor apparatus 220 and fluids mixed therein) proximate the outlet pipe 225. Reducing the viscosity of the material mixture being conveyed or displaced into the outlet pipe 225 may allow the mixture of materials to be successfully displaced through the outlet pipe 225 to a storage vessel (not shown) or an active drilling fluid system (not shown). In one or more embodiments, the outlet pipe 225 may be in fluid communication with a sump of the vibratory separator (not shown).

Further, as shown in FIG. 2, the collection trough 205 includes a scraper 226 disposed therein that may be in contact with a surface of the conveying apparatus 220. In one or more embodiments, the scraper 226 may be configured to contact the conveyor belt 221 proximate the first end 209 of the collection trough 205 such that material that may be stuck on or adhered to the conveyor belt 221 may be scraped off and into the outlet pipe 225. For example, in one or more embodiments, the scraper 226 may include a flexible body that may be flexed against the conveyor belt 221 to promote consistent contact with the conveyor belt 221 and to maximize the amount of material scraped off of the conveyor belt 221 as that portion of the conveyor belt rotates proximate the outlet pipe 225. In one or more embodiments, the scraper 226 may include an angled body, as shown in FIG. 2, such that material may slide down a portion of the scraper 226 and into the outlet pipe 225. Further, in one or more embodiments, the scraper 226 may be coupled to a portion of the collection trough 205. In one or more embodiments, the scraper 226 may be coupled to a portion of the outlet pipe 225. One or ordinary skill in the art will appreciate that the scraper 226 may be locate anywhere within collection trough 205, such that at least a portion of the scraper surface contacts a surface of the conveyor belt 221 to remove material from the conveyor belt 221.

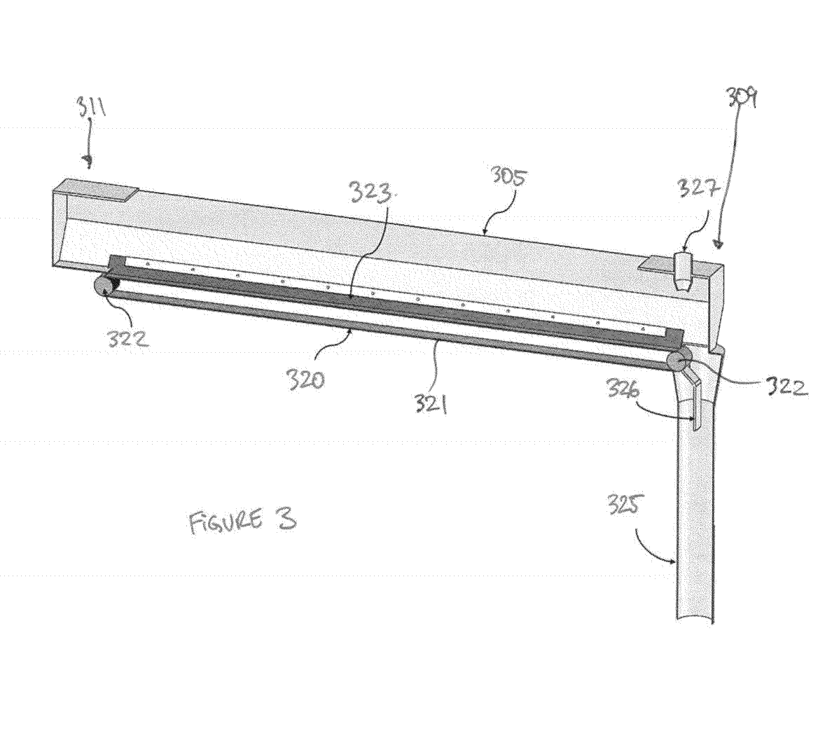

Referring to FIG. 3, a cut away perspective view of a collection trough 305, in which a conveyor apparatus 320 forms a bottom surface of the collection trough 305, according to embodiments of the present disclosure, is shown. As shown, the collection trough 305 includes a first end 309 and a second end 311, and an outlet pipe 325, a scraper 326, and a fluid inlet nozzle 327 disposed proximate the second end 311 of the collection trough 305. Further, as shown, the conveyor apparatus 320 includes a conveyor belt 321 and a plurality of rollers 322.

As shown in FIG. 3, the conveyor apparatus 320 forms the bottom surface of the collection trough 305. As such, any materials that are disposed in the collection trough 305 that collect on the bottom surface of the collection trough 305 may be conveyed or displaced by the conveyor apparatus 320. As discussed above, the plurality of rollers 322 may be configured to rotate in a first direction or a second direction (e.g., the clockwise direction or the counter-clockwise direction) by way of a variety of motors and rotation mechanisms, which may cause the conveyor belt 321 to rotate in the first direction or the second direction. For example, if the rollers 322 were rotating in the clockwise direction, the conveyor belt 321 may also be forced to rotate in the clockwise direction, which may convey or displace any materials that have collected on the bottom surface of the collection trough (e.g., on the conveyor belt 321) toward the outlet pipe 325.

Further, as shown, the collection trough 305 may also include one or more seals 323 disposed between a wall of the collection trough 305 and the conveying apparatus 320. In one or more embodiments, the one or more seals 323 may be provided to prevent materials disposed in the collection trough 305 from escaping from or bypassing the collection trough 305. In other words, the one or more seals 323 are configured to prevent inadvertent loss of materials from the collection trough 305. In one or more embodiments, the one or more seals 323 that are attached to the collection trough 305 may extend from a wall or surface of the collection trough 305 to the conveyor apparatus 320 along a length of the conveyor belt 321 of the conveyor apparatus 320. The one or more seals 323 may contact and edge surface of the conveyor belt 321 but not restrict movement of the conveyor belt 321. Further, in one or more embodiments, the bottom surface of the collection trough 305 may also include overlapping seals (e.g., rubber seals) that may prevent materials from escaping from within the collection trough 305. Furthermore, in one or more embodiments, the one or more seals 323 may include a splitter piece that may extend along a length of the collection trough 305 periodically, which may move the overlapping seals apart and allow the materials to fall onto the conveyor belt 321 and be conveyed or displaced toward the outlet pipe 325.

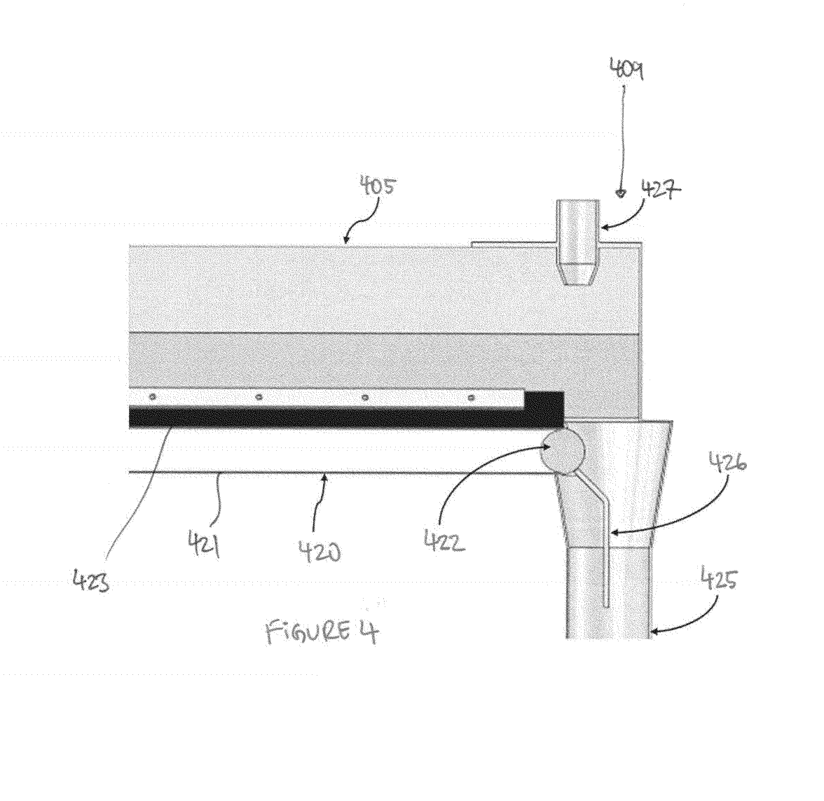

Referring to FIG. 4, a close-up view of a first end 409 of a collection trough 405 according to embodiments of the present disclosure is shown. As shown, the collection trough 405 includes a conveyor apparatus 420 forming a bottom surface of the collection trough 405. The conveyor apparatus 420 may include a conveyor belt 421 and a plurality of rollers 422 (only one roller is shown), the roller 422 configured to rotate in a first direction or a second direction (e.g., the clockwise direction or the counter-clockwise direction) to cause the conveyor belt 421 to rotate in the first direction or the second direction. Further, as shown, the collection trough 405 includes a seal 423 disposed thereon, the seal 423 configured to seal materials disposed within the collection trough 405 (e.g., materials disposed on the conveyor belt 421) within the collection trough 405.

Further, as shown in FIG. 4, the collection trough 405 also includes an outlet pipe 425, a scraper 426, and a fluid inlet nozzle 427 disposed proximate the first end 409 of the collection trough 405. In one or more embodiments, the outlet pipe 425 may direct materials from the collection trough 405 to a storage vessel (not shown) or an active drilling fluid system (not shown). In one or more embodiments, the scraper 426 may be in contact with a surface of the conveying apparatus 420. In one or more embodiments, the scraper 426 may be configured to contact the conveyor belt 421 proximate the first end 409 of the collection trough 405 such that debris on the conveyor belt 421 may be scraped off the conveyor belt 421 and into the outlet pipe 425. In one or more embodiments, the fluid inlet nozzle may be positioned above the outlet pipe 425 and may allow additional fluid to be introduced into the collection trough 405 to reduce the viscosity of the material mixture proximate the outlet pipe 425. Reducing the viscosity of the material mixture being conveyed or displaced into the outlet pipe 425 may allow the mixture of materials to be successfully displaced through the outlet pipe 425 to the storage vessel or the active drilling fluid system.

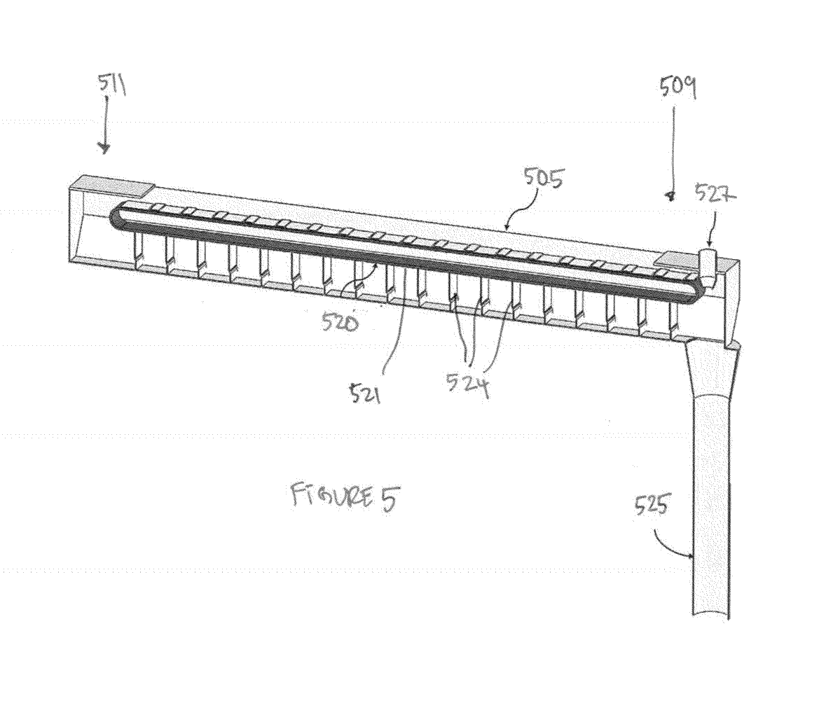

Referring to FIG. 5, a cut away perspective view of a collection trough 505 having a conveyor apparatus 520 with at least one flap 524 disposed thereon according to embodiments of the present disclosure is shown. As shown, the collection trough 505 has a first end 509 and a second end 511, in which an outlet pipe 525 and a fluid inlet nozzle 527 are disposed proximate the first end 509 of the collection trough 505. In one or more embodiments, the conveyor apparatus 520 may include a conveyor belt 521 and a plurality of rollers (not shown).

As shown, the conveyor belt 521 includes a plurality of flaps 524 extending outward from the conveyor belt 521. In one or more embodiments, the plurality of flaps 524 may be attached to the conveyor belt 521. Alternatively, in one or more embodiments, the plurality of flaps 524 may be formed as part of an outer portion of the conveyor belt 521. The plurality of flaps 524 may be formed from substantially the same material from which one or more layers of the conveyor belt 521 are formed. Alternatively, the plurality of flaps 524 may be formed from one or more materials that are independent of the conveyor belt 521. For example, the plurality of flaps 524 may be formed from rubber, plastic, metal, or a combination thereof. Although a plurality of flaps 524 are shown in FIG. 5, one or more embodiments of the present disclosure may include a single flap disposed or formed on the conveyor belt 521.

In one or more embodiments, the plurality of flaps 524 may be configured to assist in moving materials disposed on the conveyor belt 521 toward the outlet pipe 525 when the conveyor belt 521 is rotating. For example, the plurality of flaps 524 on the conveyor belt 521 may act as a backstop for materials disposed thereon such that slippage between the materials disposed on the conveyor belt 521 and the conveyor belt itself 521 may be minimized. As such, as the conveyor belt 521 is rotating in a first direction, movement of the materials in a direction opposite of the first direction may be minimized by the plurality of flaps 524 extending outward from the conveyor belt 521, because the plurality of flaps 524 may limit movement of the materials disposed on the conveyor belt 521.

Further, in one or more embodiments, the plurality of flaps 524 extending from the conveyor belt 521 may be flexible such that the plurality of flaps 524 may deform on contact if forced against one or more portions of the collection trough 505. For example, as shown, the conveyor apparatus 520 is disposed within the collection trough 505. In one or more embodiments, the plurality of flaps 524 may contact and deform against one or more portions of the collection trough 505 such as a bottom surface or a top surface of the collection trough 505.

Furthermore, in one or more embodiments, the plurality of flaps 524 extending from the conveyor belt 521 may be textured and/or a portion of the plurality of flaps 524 may be angled or configured to otherwise assist in limiting movement of the materials disposed on the conveyor belt 521. For example, as shown in FIG. 5, a portion of the plurality of flaps 524 are angled, which may assist in limiting movement of the materials disposed on the conveyor belt 521.

In other embodiments, the conveyor belt 521 may be formed from a plurality of overlapping flaps 524 that mesh and un-mesh to transport or convey collected material in the collection trough 505 toward outlet pipe 525. For example, as shown in FIG. 5, when the plurality of flaps 524 are below the rollers (not shown), the plurality of flaps 524 extend downwardly due to gravity. Thus, the plurality of flaps 524 move and collect the material in the collection trough 505. In this position, adjacent flaps of the plurality of flaps 524 are not overlapping. However, as the conveyor belt 521 rotates and the flaps move to a position above the rollers (not shown), the plurality of flaps 524 fall and overlap one other (mesh), thereby capturing or securing the collected material. As the flap reaches the first end 509 of the collection trough, and the outlet pipe 525, the flaps open again (un-mesh) due to gravity, thereby depositing the collected material proximate the outlet pipe 525.

One or more aspects of the present disclosure are directed to a method including providing a flow of drilling fluid from a wellbore to a screening deck of a vibratory separator, separating the drilling fluid into a filtrate and an overflow, directing the overflow to a collection trough coupled the screening deck, and conveying the overflow to an outlet of the collection trough with a conveyor.

For example, a flow of drilling fluid from a wellbore may be provided to a screening deck of a vibratory separator 100 shown in FIG. 1. The drilling fluid may be separated through one or more screen decks 101, 102, and/or 103 into filtrate and a solids portion, and a solids portion may be directed along the second screen deck 102 toward a collection trough (e.g., the collection trough 105 shown in FIG. 1 and/or the collection trough 205 shown in FIG. 2). The solids portion of the materials may be conveyed to an outlet (e.g., toward the outlet pipe 225 shown in FIG. 2) with a conveyor (e.g., the conveyor apparatus 220).

In one or more embodiments, conveying the solids portion to an outlet of the collection trough with a conveyor includes rotating at least one roller and moving a conveyor belt around the at least one roller. The method may also include injecting a fluid into the collection trough. As discussed above with regard to FIG. 2, the plurality of rollers 222 may be configured to rotate in a first direction or a second direction (e.g., the clockwise direction or the counter-clockwise direction) by way of a variety of motors and rotation mechanism (e.g., directly by an electric motor, a pneumatic motor, or a magnetically driven motor, or indirectly through a gear box). Further, in one or more embodiments, only one of the plurality of rollers 222 may be powered or driven, and the remaining rollers 222 may be free to rotate with the conveyor belt 221.

The method may also include providing a seal between the conveyor and at a wall of the collection trough. As discussed above with regard to FIG. 3, the collection trough 305 may also include one or more seals 323 disposed between a wall of the collection trough 305 and the conveying apparatus 320. In one or more embodiments, the one or more seals 323 may be provided to prevent materials disposed in the collection trough 305 from escaping from the collection trough 305.

The method may also include applying a scraper to a surface of the conveyor belt as the conveyor belt moves around the at least one roller. Referring back to FIG. 2, the collection trough 205 may include a scraper 226 disposed therein that may be in contact with a surface of the conveying apparatus 220. In one or more embodiments, the scraper 226 may be configured to contact the conveyor belt 221 proximate the first end 209 of the collection trough 205 such that debris on the conveyor belt 221 may be scraped off and into the outlet pipe 225. For example, in one or more embodiments, the scraper 226 may include a flexible body that may be flexed against the conveyor belt 221 to promote consistent contact with the conveyor belt 221 and to maximize the amount of debris is scraped off of the conveyor belt 221 as that portion of the conveyor belt rotates proximate the outlet pipe 225.

The method may also include meshing and un-meshing overlapping flaps of the conveyor. As discussed above with regard to the conveyor belt 221, one or more embodiments of the conveyor belt disclosed herein may include one or more layers that may be formed from a variety of materials and are not limited to rubber (e.g., non-stick rubber), plastic (e.g., nylon), polyester, cotton, metal, or a combination thereof. In one or more embodiments, the conveyor belt 221 may include overlapping flaps configured to mesh and un-mesh. Further, in one or more embodiments, the conveyor belt 221 may be textured or perforated.

In one or more embodiments, the speed of rotation of the conveyor belt may be dependent on the flow rate of the material mixture being introduced into the collection trough. The density of the material mixture introduced into the collection trough may also affect the speed of rotation of the conveyor belt.

Although only a few example embodiments have been described in detail above, those skilled in the art will readily appreciate that many modifications are possible in the example embodiments without materially departing from scope of embodiments described herein. Accordingly, all such modifications are intended to be included within the scope of this disclosure.

What is claimed:

1. An apparatus comprising:
a vibratory separator having a first deck, a second deck, and a third deck; and
a collection trough coupled to at least one of the first deck, the second deck and the third deck, the collection trough including a conveying apparatus configured to convey a material in the collection trough to an outlet of the collection trough disposed proximate a first end of the collection trough.

2. The apparatus of claim 1, the collection trough further comprising a fluid inlet nozzle.

3. The apparatus of claim 1, wherein the conveying apparatus comprises a conveyor belt disposed around two rollers.

4. The apparatus of claim 1, wherein the conveying apparatus is disposed within the collection trough.

5. The apparatus of claim 1, wherein the conveying apparatus forms a bottom surface of the collection trough.

6. The apparatus of claim 5, wherein the collection trough further comprises a seal disposed between a wall of the collection trough and the conveying apparatus.

7. The apparatus of claim 1, further comprising a scraper in contact with a surface of the conveying apparatus.

8. An apparatus comprising:
a vibratory separator including:
a deck having a screen; and
a collection trough coupled to the deck, the collection trough including:
a first end and a second end;
a first side extending between the first end and the second end;
an inlet configured to receive a material retained on a surface of the screen;
an outlet; and
a conveyor configured to move the material from inside the collection trough to the outlet.

9. The apparatus of claim 8, wherein the collection trough further comprises a fluid inlet located proximate the outlet.

10. The apparatus of claim 8, wherein the outlet is in fluid communication with a sump of the vibratory separator.

11. The apparatus of claim 8, wherein the conveyor comprises a conveyor belt disposed around two rollers, at least one roller coupled to a motor.

12. The apparatus of claim 11, wherein the conveyor belt is perforated.

13. The apparatus of claim 11, wherein the conveyor belt includes at least one flap extending outward from the conveyor belt.

14. The apparatus of claim 11, wherein at least one roller is spring mounted proximate a bottom surface of the collection trough.

15. A method comprising:
providing a flow of drilling fluid from a wellbore to a screening deck of a vibratory separator;
separating the drilling fluid into a filtrate and a solids portion;
directing the solids portion to a collection trough coupled the screening deck;
conveying the solids portion to an outlet of the collection trough with a conveyor.

16. The method of claim 15, wherein the conveying comprises rotating at least one roller and moving a conveyor belt around the at least one roller.

17. The method of claim 15, further comprising injecting a fluid into the collection trough.

18. The method of claim 15, further comprising providing a seal between the conveyor and at a wall of the collection trough.

19. The method of claim 16, further comprising applying a scraper to a surface of the conveyor belt as the conveyor belt moves around the at least one roller.

20. The method of claim 15, wherein the conveying comprises meshing and un-meshing overlapping flaps of the conveyor.
